(19) United States
(12) Patent Application Publication
(10) Pub. No.: US 2013/0034381 A1
(43) Pub. Date: Feb. 7, 2013

(54) Swiveling Device for Connecting Swimming Pool Flotation Noodles

(71) Applicants: Alastair Stuart McDonald, Laveen, AZ (US); Douglas Brant Slader, Glendale, AZ (US); Hendrik Unck, Tempe, AZ (US)

(72) Inventors: Alastair Stuart McDonald, Laveen, AZ (US); Douglas Brant Slader, Glendale, AZ (US); Hendrik Unck, Tempe, AZ (US)

(21) Appl. No.: 13/198,034

(22) Filed: Aug. 4, 2011

(51) Int. Cl. F16C 11/04

(52) U.S. Cl. 403/164

(57) ABSTRACT

A swiveling cuff-like device which connects flotation noodles that are used in swimming pools for recreation and physical therapy. Two sponge-rubber rings, connected with a single snap-rivet, slide onto flotation noodles to connect them together. The locking snap rivet allows the two rings to rotate independent of each other, creating an articulating connection between the flotation noodles.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Device is intended for use in water recreation activities, and aqua therapy applications. It solves two problems of exiting connectors: (1) No articulation capability, in existing connectors, which only allow connecting flotation noodles together at rigid 90-degree angles, and (2) Existing connectors have poor connection capability, thus often coming apart easily.

This Device enables (1) an articulated connection capability, which allows the attaching together of multiple noodles in nearly any configuration, and (2) solves the secure attachment problem with its cuff-like construction, which enables it to securely hold its grip on flotation noodles, while still easy to attach and remove.

### BRIEF SUMMARY OF INVENTION

The Device connects together flotation noodles, as commonly used in swimming pools for recreation and aqua therapy by securely surrounding the flotation noodles in a cuff-like manner. The Device's swivel feature enables the construction of a number of useful and fanciful items that the user wishes to create. Examples of useful creations would include: rafts, floating reclining loungers, floating chairs, floating beverage caddy, and goal nets for swimming pool games. Fanciful item would be anything that the user's imagination can conjure up, such as different types of noodle sculptures.

Noodle connectors currently available allow connections only at right angles, thereby greatly limiting their utility and usefulness. The Device allows movement at different angles, while remaining securely attached to the flotation noodle.

Noodle connectors that are currently manufactured do not create secure attachment, causing noodle creations to easily come apart, which is frustrating and, at times, detrimental to the activity in which they are being utilized.

### BRIEF DESCRIPTION OF THE SEVERAL VIEWS OF THE DRAWING

FIG. 1: Cross-section side view of the Device showing two sponge-rubber rings (1) attached together by a non-corrosive rivet (parts 3A and 3B) through a hole (2) centered in the wall of each ring.

FIG. 2: Isometric exploded assembly view of the Device, showing the sponge rubber rings (1); the holes (2) to accommodate the rivet; and the two-part rivet, male part (3A), and female part (3B).

FIG. 3: End view showing the two sponge rubber rings (1) connected together with the two rivet halves (3A and 3B), through the holes (2) in the walls of the rings.

### REFERENCE NUMERALS

1. Sponge rubber ring
2. Hole
3. Two-piece rivet
   a. Male part
   b. Female part

### DETAILED DESCRIPTION OF INVENTION

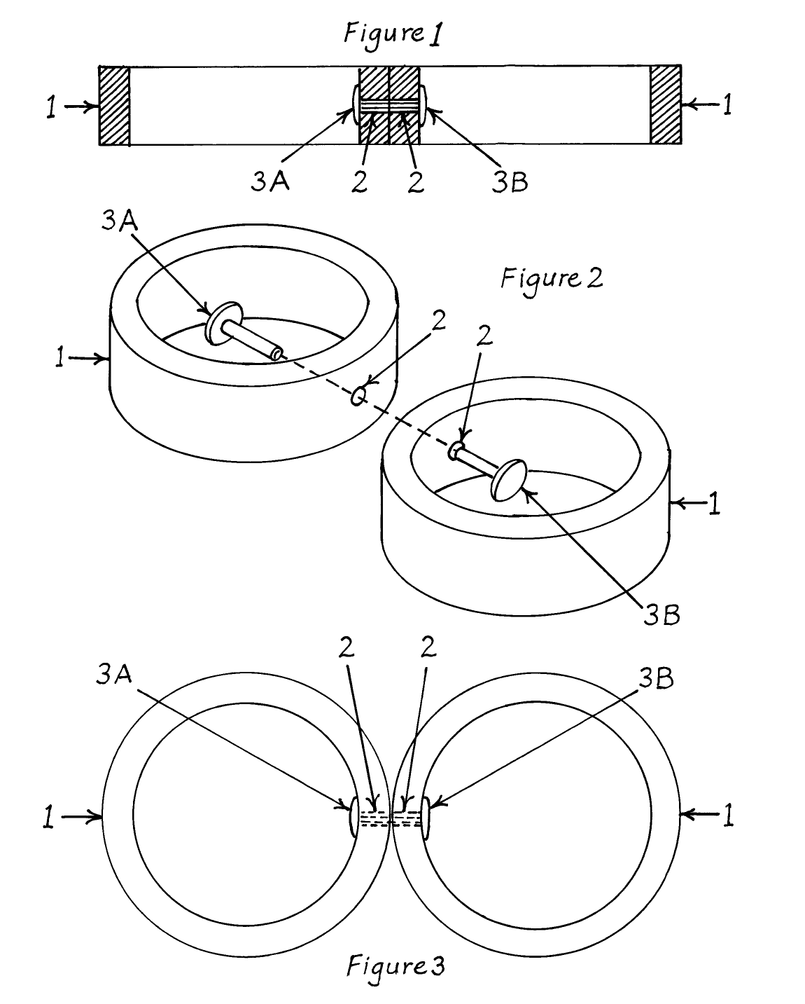

The Device is manufactured from rings of sponge-rubber material with an inside circumference slightly smaller than the outside circumference of flotation noodles (Drawing FIG. 3). Either a manual or mechanical punch may be used to create a small hole in the side of each ring to accommodate a rivet (Drawing FIG. 2). A corrosion-resistant locking snap-rivet is inserted through the holes (Drawing FIGS. 1, 2, 3) and secured in place in order to connect the two rings, and allow independent rotation of each ring, thereby creating an swiveling device for connecting flotation noodles.

We claim:

1. A cuff-like device that connects flotation noodles, which are used in swimming pools for recreation, and physical therapy. Comprising: two independent swiveling sponge-rubber rings that slide onto the flotation noodles, and a single corrosion-resistant locking snap-rivet to connect the two rings together. The locking snap rivet allows the two rings to rotate independent of each other, in order to create an articulating connection between flotation noodles.
